(19) United States
(12) Patent Application Publication
(10) Pub. No.: US 2025/0289235 A1
(43) Pub. Date: Sep. 18, 2025

(54) PRINTING APPARATUS AND PRINT CONTROL METHOD

(71) Applicant: SCREEN Holdings Co., Ltd., Kyoto (JP)

(72) Inventors: Kazuhiko ASADA, Kyoto (JP); Ikuhiko Takahama, Kyoto (JP); Shinsuke Yamashita, Kyoto (JP)

(21) Appl. No.: 19/047,528

(22) Filed: Feb. 6, 2025

(30) Foreign Application Priority Data
Mar. 18, 2024 (JP) 2024-041966

(51) Int. Cl. B41J 2/195; B41J 2/17; B41J 2/175; B41J 2/18; B41J 29/377

(52) U.S. Cl. CPC B41J 2/195; B41J 2/1707; B41J 2/17596; B41J 2/18; B41J 29/377

(57) ABSTRACT

The sensor is provided which detects the ink or air bubbles in the pressure transmission pipe between the supply tank and the air filter. Therefore, the overflow of the ink or air bubbles to the pressure transmission pipe connecting the supply tank and the pressure generator can be detected before these reach the air filter provided in the pressure transmission pipe.

### CROSS REFERENCE TO RELATED APPLICATION

The disclosure of Japanese Patent Application No. 2024-041966 filed on Mar. 18, 2024 including specification, drawings and claims is incorporated herein by reference in its entirety.

### BACKGROUND

### Technical Field

This disclosure relates to a technique for coping with an overflow of an ink and air bubbles from a reservoir tank communicating with a recording head for discharging the ink.

### Background Art

An inkjet printing apparatus shown in JP5777581 and JP2007-160773A is provided with a recording head for discharging an ink and a reservoir tank communicating with the recording head, and the ink is fed between the recording head and the reservoir tank.

### SUMMARY

In such a printing apparatus, a pressure (negative pressure) applied to the reservoir tank is controlled to optimize the meniscus shape of the ink in the recording head. Specifically, a pressure generator and the reservoir tank are allowed to communicate by an air pipe, and a pressure generated by the pressure generator is applied to the reservoir tank via the air pipe. Further, an air filter is provided in the air pipe to prevent the mixing of foreign matters into the reservoir tank.

The ink may overflow from the reservoir tank to the air pipe due to the breakdown of the printing apparatus or the like. Alternatively, as indicated in patent literature 2, air is possibly mixed into the ink. If the ink foams in the reservoir tank due to such mixing of air, air bubbles may overflow from the reservoir tank to the air pipe. If the ink or air bubbles overflowing to the air pipe reach the air filter and wets the air filter, the pressure generated by the pressure generator is not applied to the reservoir tank. As a result, there has been a possibility that the ink flows out from the recording head and the inside of the printing apparatus and a floor, on which the printing apparatus is stalled, are contaminated with the ink.

This disclosure was developed in view of the above problem and aims to enable detection of the overflow of an ink or air bubbles to an air pipe connecting a reservoir tank and a pressure generator before these reach an air filter provided in the air pipe.

A printing apparatus according to the disclosure, comprises: a first reservoir tank which stores an ink; a recording head which includes an ink storage chamber, which is connected to a first ink storage part being a part below an ink liquid surface in the first reservoir tank and communicates with the first ink storage part, and discharges the ink stored in the ink storage chamber from a nozzle; a first pressure generator which generates a first pressure; a first air pipe which applies the first pressure generated by the first pressure generator to a first space, which is above the ink liquid surface in the first reservoir tank, by connecting the first space and the first pressure generator; a first air filter which is provided in the first air pipe between the first reservoir tank and the first pressure generator and removes foreign matters from air in the first air pipe; and a sensor which detects the ink or air bubbles in the first air pipe between the first reservoir tank and the first air filter.

A print control method according to the disclosure, comprises: applying a first pressure to a first space via a first air pipe, the first pressure being generated by a first pressure generator for generating the first pressure, the first space being above an ink liquid surface in a first reservoir tank for storing an ink, the first air pipe connecting the first space and the first pressure generator; discharging the ink stored in an ink storage chamber from a nozzle by a recording head including the ink storage chamber, which is connected to the first ink storage part to communicate with a first ink storage part, the first ink storage part being a part below the ink liquid surface in the first reservoir tank; and detecting the ink or air bubbles in the first air pipe between a first air filter and the first reservoir tank by a sensor, the first air filter being provided in the first air pipe between the first reservoir tank and the first pressure generator to remove foreign matters from air in the first air pipe.

In the disclosure (printing apparatus and print control method) thus configured, the sensor is provided which detects the ink or air bubbles in the first air pipe between the first reservoir tank and the first air filter. Therefore, the overflow of the ink or air bubbles to the air pipe connecting the reservoir tank and the pressure generator can be detected before these reach the air filter provided in the air pipe.

As described above, according to the disclosure, it is possible to detect the overflow of an ink or air bubbles to an air pipe connecting a reservoir tank and a pressure generator before these reach an air filter provided in the air pipe.

The above and further objects and novel features of the disclosure will more fully appear from the following detailed description when the same is read in connection with the accompanying drawing. It is to be expressly understood, however, that the drawing is for purpose of illustration only and is not intended as a definition of the limits of the disclosure.

### BRIEF DESCRIPTION OF THE DRAWINGS

FIG. 1 is a front view schematically showing a printing apparatus according to the disclosure.

FIG. 2 is a diagram schematically showing the bottom surfaces of the discharge heads H provided in the head unit 321, 331.

FIG. 3 is a diagram schematically showing the discharge head H and the ink circulation mechanism 9 which circulatingly supplies the ink to the discharge head H.

FIG. 4 is a block diagram showing an electrical configuration provided in the printing apparatus 3 for controlling the ink circulation mechanism 9 of FIG. 3.

FIG. 5 is a perspective view partially showing the external configurations of the discharge head and the ink circulation mechanism.

FIG. 6 is a table showing a plurality of modes executable in the ink circulation mechanism in FIG. 3.

FIG. 7A is diagram schematically showing modifications of the air buffer.

FIG. 7B is diagram schematically showing modifications of the air buffer.

### DETAILED DESCRIPTION

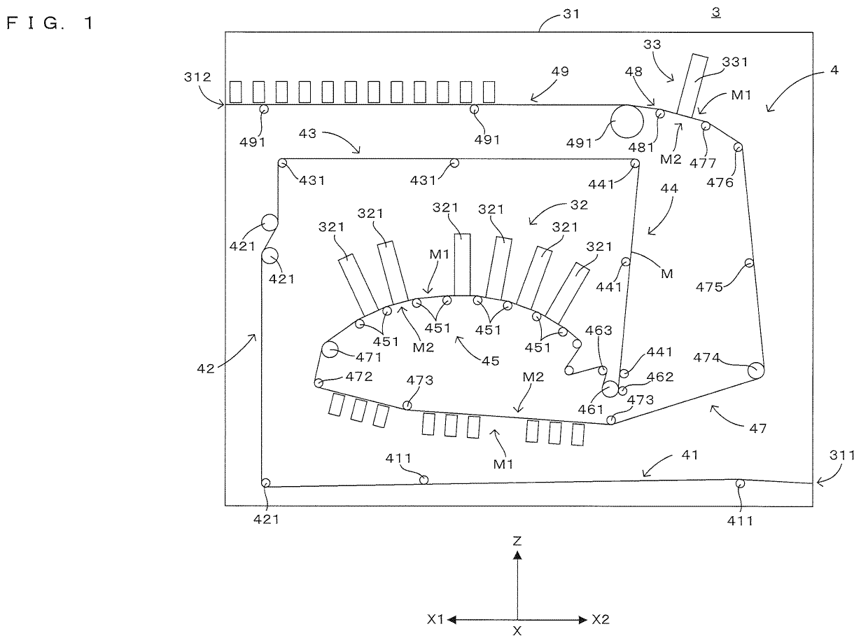

FIG. 1 is a front view schematically showing a printing apparatus according to the disclosure. In FIG. 1, an X direction, which is a horizontal direction, and a Z direction, which is a vertical direction, are shown. Further, one side X1 and another side X2 in the X direction opposite to each other are shown. A printing apparatus 3 is provided with a housing 31, a color printer 32 arranged in the housing 31, a white printer 33 arranged above the color printer 32 in the housing 31 and a conveyor 4 for conveying a printing medium M by a plurality of rollers arranged in the housing 31.

The color printer 32 includes a plurality of (six) head units 321 arrayed in a moving direction (direction from the other side X2 to the one side X1) of the printing medium M above the printing medium M being conveyed by the conveyor 4. The plurality of head units 321 include nozzles facing a front surface1 of the printing medium M passing therebelow from above and discharge color inks of mutually different colors in an inkjet method. Here, the color inks mean inks other than a white ink and include inks of cyan, magenta, yellow, black and the like. In this way, the plurality of head units 321 of the color printer 32 print a color image on the front surface1 of the printing medium M by discharging the color inks to the front surface1 of the printing medium M passing therebelow from above.

Further, the white printer 33 includes a single head unit 331 arranged above the printing medium M being conveyed by the conveyor 4. The head unit 331 includes nozzles facing the front surface1 of the printing medium M passing therebelow from above and discharges the white ink from the nozzles in the inkjet method. In this way, the head unit 331 of the white printer 33 prints a white image on the front surface1 of the printing medium M by discharging the white ink to the front surface1 of the printing medium M passing therebelow from above.

A carry-in port 311 is open in a side wall on the other side X2 of the housing 31, whereas a carry-out port 312 is open in a side wall on the one side X1 of the housing 31. The conveyor 4 conveys the printing medium M from the carry-in port 311 to the carry-out port 312 by way of the above color printer 32 and white printer 33.

This conveyor 4 includes a carry-in part 41 provided below the color printer 32, an ascending conveyor 42 provided on the one side X1 of the color printer 32, an upper conveyor 43 provided above the color printer 32 and a descending conveyor 44 provided on the other side X2 of the color printer 32. The carry-in part 41 conveys the printing medium M carried in through the carry-in port 311 toward the one side X1 by rollers 411, the ascending conveyor 42 conveys the printing medium M conveyed by the carry-in part 41 upward by rollers 421, the upper conveyor 43 conveys the printing medium M conveyed by the ascending conveyor 42 toward the other side X2 by rollers 431 and the descending conveyor 44 conveys the printing medium M conveyed by the upper conveyor 43 downward by rollers 441.

Further, the conveyor 4 includes a color conveyor 45 for supporting the printing medium M facing the color printer 32 from below. The printing medium M passed through the descending conveyor 44 enters the color conveyor 45. This color conveyor 45 includes a plurality of rollers 451 arrayed from the other side X2 toward the one side X1 and each roller 451 contacts a back surface M2 of the printing medium M from below. In this way, the front surface of the printing medium M supported by the color conveyor 45 faces upward and each head unit 321 of the color printer 32 discharges the color ink while facing this front surface from above.

Further, the conveyor 4 includes rollers 461, 462 and 463 arranged between the color conveyor 45 and the descending conveyor 44 in the moving direction of the printing medium M. The roller 461 is a drive roller for driving the printing medium M. The rollers 462, 463 are driven rollers configured to rotate, following the printing medium M.

Further, the conveyor 4 includes an inverting conveyor 47 for vertically inverting the printing medium M conveyed to the one side X1 from color conveyor 45 twice. This inverting conveyor 47 includes a plurality of rollers 471 to 477 including the drive roller 471, and these rollers 471 to 477 vertically invert the printing medium M twice while contacting the back surface M2 of the printing medium M. That is, the inverting conveyor 47 vertically inverts the front surface1 and the back surface M2 of the printing medium M by conveying the printing medium M conveyed from the color conveyor 45 downward by the rollers 471, 472 and further changing and conveying the moving direction of the printing medium M toward the other side X2 by the roller 472. Subsequently, the inverting conveyor 47 conveys the printing medium M from the one side X1 toward the other side X2 by a plurality of the rollers 473 and, then, conveys the printing medium M upward by the rollers 474 to 476. Further, the inverting conveyor 47 vertically inverts the front surface1 and the back surface M2 of the printing medium M again by changing the moving direction of the printing medium M toward the one side X1 by the roller 476, and conveys the printing medium M from the other side X2 toward the one side X1 by the roller 477.

Further, the conveyor 4 includes a white conveyor 48 for supporting the printing medium M facing the white printer 33 from below, and the printing medium M vertically inverted twice by the inverting conveyor 47 enters the white conveyor 48. This white conveyor 48 includes a roller 481 contacting the back surface M2 of the printing medium M from below. In this way, the front surface1 of the printing medium M supported by the white conveyor 48 faces upward, and the head unit 331 of the white printer 33 discharges the white ink while facing the front surface1 from above.

Further, the conveyor 4 includes a carry-out part 49 provided above the upper conveyor 43. The carry-out part 49 includes a plurality of rollers 491 arrayed from the other side X2 to the one side X1 in the X direction. This carry-out part 49 carries out the printing medium M through the carry-out port 312 of the housing 31 by conveying the printing medium M, conveyed by the white conveyor 48, toward the one side X1 by the plurality of rollers 491.

As described above, the color printer 32 and the white printer 33 of the printing apparatus 3 include the head units 321, 331. Next, a discharge head H of the head unit 321, 331 and an ink circulation mechanism 9 for circulatingly supplying the ink to the discharge head H are described. Note that basic configurations of the discharge head H and the ink circulation mechanism 9 are common to each of the head unit 331 for discharging the white ink and the head units 321 for discharging the color inks. Thus, a configuration for the head unit 331 for discharging the white ink is described here.

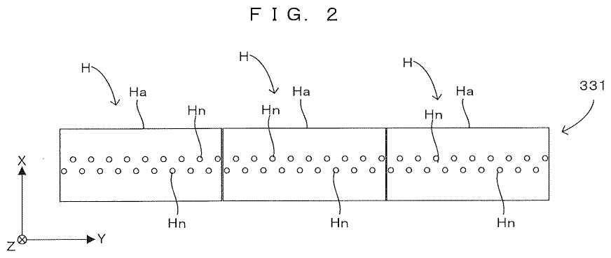

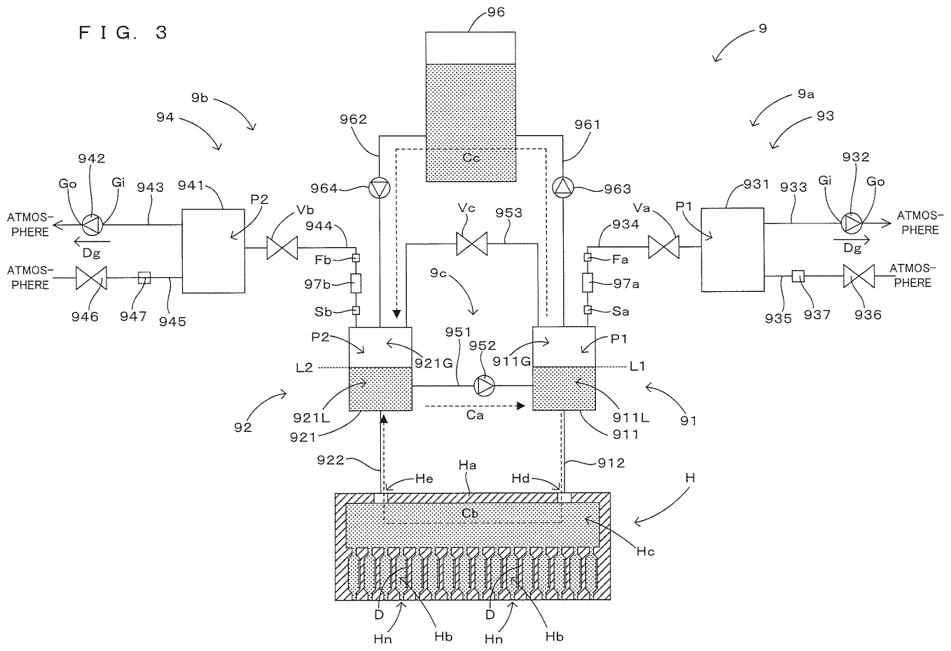

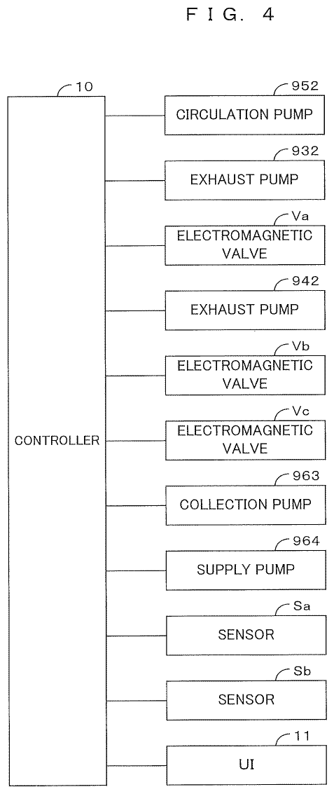

FIG. 2 is a diagram schematically showing the bottom surfaces of the discharge heads H provided in the head unit 321, 331, FIG. 3 is a diagram schematically showing the discharge head H and the ink circulation mechanism 9 which circulatingly supplies the ink to the discharge head H, and FIG. 4 is a block diagram showing an electrical configuration provided in the printing apparatus 3 for controlling the ink circulation mechanism 9 of FIG. 3. A horizontal direction Y orthogonal to the horizontal direction X is shown besides the horizontal direction X and the vertical direction Z in FIG. 2.

As shown in FIG. 4, the printing apparatus 3 includes a controller 10. The controller 10 is, for example, a processor such as a CPU (Central Processing Unit). Further, the printing apparatus 3 is provided with a UI (User Interface) 11. The UI 11 includes an output device such as a display or a speaker, and notifies an operator by means of image display on the display or an audible output by the speaker.

As shown in FIG. 2, a plurality of the discharge heads H for discharging the ink of the same color (white ink) are arrayed in a row in the horizontal direction Y in the head unit 331, and each discharge head H has a rectangular shape in a bottom view. Note that the shape of the discharge head H is not limited to an example of FIG. 2 and may be a parallelogram shape. Further, an array mode of the plurality of discharge heads H is not limited to an example of FIG. 2 and the plurality of discharge heads H may be arrayed in a staggered manner.

As shown in FIG. 3, the discharge head H includes a housing Ha, and a plurality of nozzles Hn are open and arrayed in a staggered manner in the horizontal direction Y in the bottom surface of the housing Ha. A plurality of cavities Hb respectively communicating with the plurality of nozzles Hn and an ink supply chamber Hc communicating with the plurality of cavities Hb are provided inside the housing Ha, and an ink supplied from the ink supply chamber Hc is stored in the cavities Hb. Further, a piezoelectric element D is provided in each cavity Hb, and a pressure variation is given to the ink in the cavity Hb by displacing the piezoelectric element D in accordance with a drive signal (electrical signal). By this pressure variation, the ink is pushed out from the cavity Hb and discharged from the nozzle Hn communicating with the cavity Hb. Further, an ink inflow port Hd and an ink outflow port He are respectively open in an upper part of the discharge head H, and the ink flows into the ink supply chamber Hc from the ink circulation mechanism 9 via the ink inflow port Hd and flows out toward the ink circulation mechanism 9 from the ink supply chamber Hc via the ink outflow port He.

The ink circulation mechanism 9 includes an ink supply mechanism 9a which supplies the ink to the ink supply chamber Hc of the discharge head H, an ink collection mechanism 9b which collects the ink from the ink supply chamber Hc of the discharge head H and an ink return mechanism 9c which returns the ink from the ink collection mechanism 9b to the ink supply mechanism 9a.

The ink supply mechanism 9a includes an ink supplier 91 which supplies the ink to the ink supply chamber Hc of the discharge head H and a pressure generator 93 which generates a supply pressure to be applied to this ink supplier 91. The ink supplier 91 includes a supply tank 911 which stores the ink to be supplied to the discharge head H and a supply pipe 912 which feeds the ink supplied from the supply tank 911 to the ink supply chamber Hc of the discharge head H. The supply tank 911 is arranged above the discharge head H. In the supply tank 911, the ink is stored in an ink storage part 911L below an air-liquid interface L1 (i.e. ink liquid surface) and air is present in a space 911G above the air-liquid interface L1.

The ink collection mechanism 9b includes an ink collector 92 which collects the ink from the ink supply chamber Hc of the discharge head H and a pressure generator 94 which generates a pressure to be applied to this ink collector 92. The ink collector 92 includes a collection tank 921 which stores the ink collected from the discharge head H and a collection pipe 922 which feeds the ink collected from the ink supply chamber Hc of the discharge head H to the collection tank 921. The collection tank 921 is arranged above the discharge head H. In the collection tank 921, the ink is stored in an ink storage part 921L below an air-liquid interface L2 (i.e. ink liquid surface) and air is present in a space 921G above the air-liquid interface L2.

The ink return mechanism 9c includes a return pipe 951 which connects the collection tank 921 and the supply tank 911. The return pipe 951 allows communication between the ink storage part 921L of the collection tank 921 and the ink storage part 911L of the supply tank 911 by connecting these. Further, the ink return mechanism 9c includes a circulation pump 952 disposed at a halfway position of the return pipe 951. The circulation pump 952 operates according to a control of the controller 10. If the controller 10 transmits a liquid feed command to the circulation pump 952, the circulation pump 952 drives the ink in the return pipe 951 from the collection tank 921 to the supply tank 911. In this way, the ink is fed from the ink storage part 921L of the collection tank 921 to the ink storage part 911L of the supply tank 911. That is, the ink return mechanism 9c can feed the ink along a first path Ca from the collection tank 921 to the supply tank 911 by the circulation pump 952. Further, if the controller 10 transmits a stop command to the circulation pump 952, the circulation pump 952 is stopped. In this way, the feed of the ink from the collection tank 921 to the supply tank 911 is stopped.

As described above, the ink supply mechanism 9a includes the pressure generator 93 which applies a pressure P1 (negative pressure) to the supply tank 911. This pressure generator 93 includes a pressure tank 931 and an exhaust pump 932 which generates the pressure P1 in the pressure tank 931 by exhausting the pressure tank 931. The exhaust pump 932 is a diaphragm pump and exhausts air sucked through an intake port Gi from an exhaust port Go. In this way, air is exhausted in an exhaust direction Dg from the intake port Gi toward the exhaust port Go. The exhaust port Go of the exhaust pump 932 is open to the atmosphere. On the other hand, the intake port Gi of the exhaust pump 932 is connected to the pressure tank 931. Further, the pressure generator 93 includes an exhaust pipe 933 made of resin and connecting the pressure tank 931 and the intake port Gi of the exhaust pump 932, and the pressure tank 931 and the intake port Gi are allowed to communicate by the exhaust pipe 933.

The exhaust pump 932 operates according to a control of the controller 10. If the controller 10 outputs an exhaust command to the exhaust pump 932, the exhaust pump 932 exhausts in the exhaust direction Dg. Accordingly, air flows out from the pressure tank 931 to the exhaust pipe 933 to be exhausted to the atmosphere. In this way, the pressure P1 is generated in the pressure tank 931. Further, if the controller 10 transmits a stop command to the exhaust pump 932, the exhaust pump 932 stops the exhaust. Note that the exhaust pump 932 is a diaphragm pump. Thus, if the exhaust pump 932 is stopped, an air flow in a direction opposite to the exhaust direction Dg is blocked by a check valve built in the diaphragm pump, and the pressure P1 in the pressure tank 931 is maintained.

Further, the pressure generator 93 includes a pressure transmission pipe 934 which connects the pressure tank 931 and the space 911G of the supply tank 911 and an electromagnetic valve Va which is provided in the pressure transmission pipe 934 between the pressure tank 931 and the supply tank 911. The pressure transmission pipe 934 allows communication between the pressure tank 931 and the space 911G of the supply tank 911. Further, the electromagnetic valve Va operates according to a control of the controller 10. If the controller 10 transmits an opening command to the electromagnetic valve Va, the electromagnetic valve Va is opened and the pressure tank 931 and the space 911G of the supply tank 911 communicate via the pressure transmission pipe 934. Thus, the pressure P1 generated in the pressure tank 931 is applied to the space 911G of the supply tank 911 via the pressure transmission pipe 934. As a result, the pressure P1 is applied to the air-liquid interface L1. If the controller 10 transmits a closing command to the electromagnetic valve Va, the electromagnetic valve Va is closed and the pressure tank 931 and the supply tank 911 are isolated from each other.

Further, the pressure generator 93 includes an atmosphere open pipe 935 which connects the pressure tank 931 and the atmosphere, an atmosphere open electromagnetic valve 936 which is disposed at a halfway position of the atmosphere open pipe 935 and an air filter 937 which is provided in the atmosphere open pipe 935 to be interposed between the atmosphere open electromagnetic valve 936 and the pressure tank 931. With the atmosphere open electromagnetic valve 936 closed, the pressure tank 931 is isolated from the atmosphere and the pressure P1 in the pressure tank 931 is maintained. On the other hand, if the atmosphere open electromagnetic valve 936 is opened, the pressure tank 931 is allowed to communicate with the atmosphere by the atmosphere open pipe 935. Thus, air flows into the pressure tank 931 from the atmosphere via the atmosphere open pipe 935, and the pressure P1 in the pressure tank 931 increases. At this time, the air filter 937 between the pressure tank 931 and the atmosphere open electromagnetic valve 936 removes foreign matters from the air before flowing into the pressure tank 931.

As described above, the ink collection mechanism 9b includes the pressure generator 94 which applies the pressure P2 (negative pressure) to the collection tank 921. This pressure generator 94 includes a pressure tank 941 and an exhaust pump 942 which generates the pressure P2 in the pressure tank 941 by exhausting the pressure tank 941. The exhaust pump 942 is a diaphragm pump and exhausts air sucked through an intake port Gi from an exhaust port Go. In this way, air is exhausted in an exhaust direction Dg from the intake port Gi to the exhaust port Go. The exhaust port Go of the exhaust pump 942 is open to the atmosphere. On the other hand, the intake port Gi of the exhaust pump 942 is connected to the pressure tank 941. Further, the pressure generator 94 includes an exhaust pipe 943 made of resin and connecting the pressure tank 941 and the intake port Gi of the exhaust pump 942, and the pressure tank 941 and the intake port Gi are allowed to communicate by the exhaust pipe 943.

The exhaust pump 942 operates according to a control of the controller 10. If the controller 10 outputs an exhaust command to the exhaust pump 942, the exhaust pump 942 exhausts in the exhaust direction Dg. Accordingly, air flows out from the pressure tank 941 to the exhaust pipe 943 to be exhausted to the atmosphere. In this way, the pressure P2 is generated in the pressure tank 941. Further, if the controller 10 transmits a stop command to the exhaust pump 942, the exhaust pump 942 stops the exhaust. Note that the exhaust pump 942 is a diaphragm pump. Thus, if the exhaust pump 942 is stopped, an air flow in a direction opposite to the exhaust direction Dg is blocked by a check valve built in the diaphragm pump, and the pressure P2 in the pressure tank 941 is maintained.

Further, the pressure generator 94 includes a pressure transmission pipe 944 which connects the pressure tank 941 and the space 921G of the collection tank 921 and an electromagnetic valve Vb which is provided in the pressure transmission pipe 944 between the pressure tank 941 and the collection tank 921. The pressure transmission pipe 944 allows communication between the pressure tank 941 and the space 921G of the collection tank 921. Further, the electromagnetic valve Vb operates according to a control of the controller 10. If the controller 10 transmits an opening command to the electromagnetic valve Vb, the electromagnetic valve Vb is opened and the pressure tank 941 and the space 921G of the collection tank 921 communicate via the pressure transmission pipe 944. Thus, the pressure P2 generated in the pressure tank 941 is applied to the space 921G of the collection tank 921 via the pressure transmission pipe 944. As a result, the pressure P2 is applied to the air-liquid interface L2. If the controller 10 transmits a closing command to the electromagnetic valve Vb, the electromagnetic valve Vb is closed and the pressure tank 941 and the collection tank 921 are isolated from each other.

Further, the pressure generator 94 includes an atmosphere open pipe 945 which connects the pressure tank 941 and the atmosphere, an atmosphere open electromagnetic valve 946 which is disposed at a halfway position of the atmosphere open pipe 945 and an air filter 947 which is provided in the atmosphere open pipe 945 to be interposed between the atmosphere open electromagnetic valve 946 and the pressure tank 941. With the atmosphere open electromagnetic valve 946 closed, the pressure tank 941 is isolated from the atmosphere and the pressure P2 of the pressure tank 941 is maintained. On the other hand, if the atmosphere open electromagnetic valve 926 is opened, the pressure tank 941 is allowed to communicate with the atmosphere by the atmosphere open pipe 945. Thus, air flows into the pressure tank 941 from the atmosphere via the atmosphere open pipe 945, and the pressure P2 in the pressure tank 941 increases. At this time, the air filter 947 between the pressure tank 941 and the atmosphere open electromagnetic valve 946 removes foreign matters from the air before flowing into the pressure tank 941.

As just described, the pressure P1 is applied to the air-liquid interface L1 in the supply tank 911 by the pressure generator 93, and the pressure P2 is applied to the air-liquid interface L2 in the collection tank 921 by the pressure generator 94. At this time, the pressure P2 applied to the collection tank 921 is lower than the pressure P1 applied to the supply tank 911. Due to this difference between the pressure P2 and pressure P1, the ink flows along a second path Cb from the supply tank 911 to the collection tank 921 via the ink supply chamber Hc of the discharge head H. Further, the ink flowing into the collection tank 921 along the second path Cb is returned to the supply tank 911 along the first path Ca by the circulation pump 952. In this way, the ink is circulated in a circulation path (second path Cb+first path Ca) returning to the supply tank 911 after reaching the collection tank 921 from the supply tank 911 via the discharge head H.

Note that ink circulation mechanism 9 includes a bypass pipe 953 which connects the supply tank 911 and the collection tank 921 and an electromagnetic valve Vc which is mounted in the bypass pipe 953 between the supply tank 911 and the collection tank 921. The bypass pipe 953 allows communication between the space 911G of the supply tank 911 and the space 921G of the collection tank 921. The electromagnetic valve Vc operates according to a control of the controller 10. If the controller 10 transmits a closing command to the electromagnetic valve Vc, the electromagnetic valve Vc is closed. In this way, the space 911G of the supply tank 911 and the space 921G of the collection tank 921 are isolated from each other. As described above, if the ink is fed along the second path Cb by generating the pressures P1 and P2 different from each other, the controller 10 closes the electromagnetic valve Vc. On the other hand, if the controller 10 transmits an opening command to the electromagnetic valve Vc, the electromagnetic valve Vc is opened. In this way, the same pressure P3 is applied to each of the air-liquid interfaces L1 and L2 and the feed of the ink along the second path Cb is stopped.

Further, the ink circulation mechanism 9 includes a main tank 96. This main tank 96 can store more ink than the supply tank 911 and the collection tank 921. The ink circulation mechanism 9 is provided with a pipe 961 which connects the main tank 96 and the supply tank 911 and a pipe 962 which connects the main tank 96 and the collection tank 921. That is, the main tank 96 communicates with the supply tank 911 via the pipe 961 and communicates with the collection tank 921 via the pipe 962.

Furthermore, the ink circulation mechanism 9 is provided with a collection pump 963 mounted in the pipe 961 between the main tank 96 and the supply tank 911 and a supply pump 964 mounted in the pipe 962 between the main tank 96 and the collection tank 921. Therefore, the ink can be collected from the supply tank 911 to the main tank 96 by the collection pump 963, and the ink can be supplied from the main tank 96 to the collection tank 921 by the supply pump 964.

Each of the collection pump 963 and the supply pump 964 operates according to a control of the controller 10. If the controller 10 transmits a liquid feed command to the collection pump 963, the collection pump 963 feeds the ink from the supply tank 911 to the main tank 96. If the controller 10 transmits a stop command to the collection pump 963, the collection pump 963 stops the feed of the ink from the supply tank 911 to the main tank 96. If the controller 10 transmits a liquid feed command to the supply pump 964, the supply pump 964 feeds the ink from the main tank 96 to the collection tank 921. If the controller 10 transmits a stop command to the supply pump 964, the supply pump 964 stops the feed of the ink from the main tank 96 to the collection tank 921.

In such a configuration, the collection pump 963 and the supply pump 964 feed the ink, whereby the ink flows along a third path Cc from the supply tank 911 to the collection tank 921 via the main tank 96. Further, the ink flowing into the collection tank 921 along the third path Cc is returned to the supply tank 911 along the first path Ca by the circulation pump 952. In this way, the ink is circulated in a circulation path (third path Cc+first path Ca) returning to the supply tank 911 after reaching the collection tank 921 via the main tank 96 from the supply tank 911.

Further, the ink supply mechanism 9a includes an air filter Fa which is provided in the pressure transmission pipe 934 between the electromagnetic valve Va and the supply tank 911. The air filter Fa removes foreign matters from air flowing in the pressure transmission pipe 934. Further, the ink supply mechanism 9a includes a sensor Sa which is provided in the pressure transmission pipe 934 between the air filter Fa and the supply tank 911. The sensor Sa detects the ink or air bubbles overflowing to the pressure transmission pipe 934 from the supply tank 911. A detection result of the sensor Sa is transmitted to the controller 10. A capacitance sensor or an optical sensor can be, for example, used as such a sensor Sa. Further, the ink supply mechanism 9a includes an air buffer 97a which is provided in the pressure transmission pipe 934 between the sensor Sa and the air filter Fa. The air buffer 97a has a smaller volume than that of the supply tank 911 and buffers the air flowing from the sensor Sa to the air filter Fa. This air buffer 97a has a function of reducing a flowing speed of the air in an air path from the sensor Sa to the air filter Fa as compared to the case where the air path is connected only by the pressure transmission pipe 934.

The ink collection mechanism 9b includes an air filter Fb which is provided in the pressure transmission pipe 944 between the electromagnetic valve Vb and the collection tank 921. The air filter Fb removes foreign matters from air flowing in the pressure transmission pipe 944. Further, the ink collection mechanism 9b includes a sensor Sb which is provided in the pressure transmission pipe 944 between the air filter Fb and the collection tank 921. The sensor Sb detects the ink or air bubbles overflowing to the pressure transmission pipe 944 from the collection tank 921. A detection result of the sensor Sb is transmitted to the controller 10. A capacitance sensor or an optical sensor can be, for example, used as such a sensor Sb. Further, the ink collection mechanism 9b includes an air buffer 97b which is provided in the pressure transmission pipe 944 between the sensor Sb and the air filter Fb. The air buffer 97b has a smaller volume than that of the collection tank 921 and buffers the air flowing from the sensor Sb to the air filter Fb. This air buffer 97b has a function of reducing a flowing speed of the air in an air path from the sensor Sb to the air filter Fb as compared to the case where the air path is connected only by the pressure transmission pipe 944.

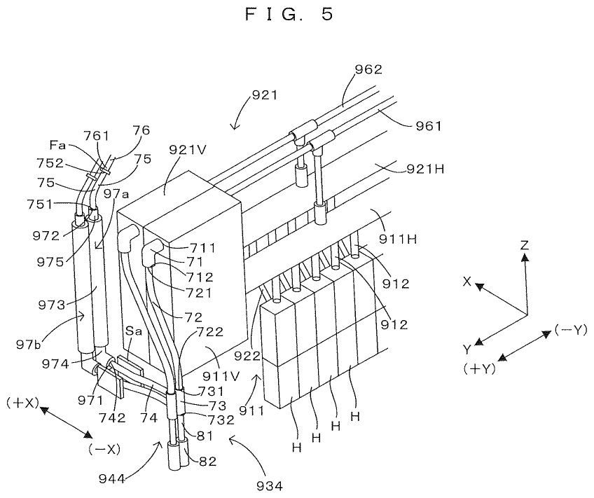

FIG. 5 is a perspective view partially showing the external configurations of the discharge head and the ink circulation mechanism. A (+X) side and a (−X) side opposite to each other in the horizontal direction X and a (+Y) side and a (−Y) side opposite to each other in the horizontal direction Y are shown in FIG. 5.

As shown in FIG. 5, the supply tank 911 includes a vertical supply tank 911V and a horizontal supply tank 911H. The vertical supply tank 911V is a tank having a rectangular parallelepiped shape long in the vertical direction Z. The horizontal supply tank 911H is a tank having a cylindrical shape long in the horizontal direction Y, and extends in parallel to the horizontal direction Y from a side surface on the (−Y) side in the horizontal direction Y of the vertical supply tank 911V. Out of the vertical supply tank 911V and the horizontal supply tank 911H, the vertical supply tank 911V is shown in FIG. 3 described above.

Similarly, the collection tank 921 includes a vertical collection tank 921V and a horizontal collection tank 921H. The vertical collection tank 921V is a tank having a rectangular parallelepiped shape long in the vertical direction Z. The horizontal collection tank 921H is a tank having a cylindrical shape long in the horizontal direction Y, and extends in parallel to the horizontal direction Y from a side surface on the (−Y) side in the horizontal direction Y of the vertical collection tank 921V. Out of the vertical collection tank 921V and the horizontal collection tank 921H, the vertical collection tank 921V is shown in FIG. 3 described above.

The vertical supply tank 911V and the vertical collection tank 921V are adjacent in the horizontal direction X without any gap therebetween. Further, the horizontal supply tank 911H and the horizontal collection tank 921H are adjacent at an interval in the horizontal direction X.

The plurality of discharge heads H arrayed in the horizontal direction Y are arranged below the horizontal supply tank 911H and the horizontal collection tank 921H in the vertical direction Z. Particularly, the respective discharge heads H face the horizontal supply tank 911H from below in the vertical direction Z. The horizontal supply tank 911H and the discharge heads H are connected by supply pipes 912 and the horizontal collection tank 921H and the discharge heads H are connected by collection pipes 922. Further, the vertical supply tank 911V is connected to the pressure tank 931 by the pressure transmission pipe 934, and the vertical collection tank 921V is connected to the pressure tank 941 by the pressure transmission pipe 944.

The pressure transmission pipe 934 connected to the supply tank 911 is provided on the (+Y) side of the vertical supply tank 911V. This pressure transmission pipe 934 includes a mounting pipe 71, a vertical pipe 72, a branch pipe 73, a horizontal pipe 74, a connection pipe 75 and a connection pipe 76. A mounting end 711 of the mounting pipe 71 is mounted on a side surface on the (+Y) side of the vertical supply tank 911V and communicates with the space 911G in the supply tank 911. The mounting pipe 71 projects toward the (+Y) side from the mounting end 711 and is bent downward in the vertical direction Z. An upper end 721 of the vertical pipe 72 is connected to a lower end 712 of the mounting pipe 71. The vertical pipe 72 extends downward obliquely to the vertical direction Z from the lower end of the mounting pipe 71. An upper end 731 of the branch pipe 73 is connected to a lower end 722 of the vertical pipe 72. The branch pipe 73 extends downward in the vertical direction Z, and a discharge pipe 81 and a drainer 82 to be described later are connected to a lower end 732 of the branch pipe 73. The branch pipe 73 includes a branch opening facing toward the (+X) side between the upper end 731 and the lower end 732, and an end on the (−X) side of the horizontal pipe 74 is connected to the branch opening of the branch pipe 73. A lower end 971 of the air buffer 97a is connected to an end 742 on the (+X) side of the horizontal pipe 74. Further, a lower end 751 of a connection pipe 75 is connected to an upper end 972 of the air buffer 97a. The connection pipe 75 extends obliquely upward from the lower end 751, and one end of the air filter Fa is connected to an upper end 752 of the connection pipe 75. Further, a lower end 761 of the connection pipe 76 is connected to the other end of the air filter Fa. That is, the air filter Fa is arranged between the upper end 752 of the connection pipe 75 and the lower end 761 of the connection pipe 76. The connection pipe 76 extends from the lower end 761 thereof and is connected to the electromagnetic valve Va.

That is, the pressure P1 generated in the pressure tank 931 is applied to the space 911G of the supply tank 911 via the connection pipe 76, the air filter Fa, the connection pipe 75, the air buffer 97a, the horizontal pipe 74, the branch pipe 73, the vertical pipe 72 and the mounting pipe 71 in this order. The pressure transmission pipe 944 has a configuration common to the pressure transmission pipe 934 except that a mounting destination of a mounting end 711 is the vertical collection tank 921V and a connection destination of a connection pipe 76 is the electromagnetic valve Vb.

Further, the printing apparatus 3 includes the discharge pipe 81 extending downward from the lower end 732 of the branch pipe 73 and the drainer 82 mounted on the lower end of the discharge pipe 81. The drainer 82 includes a lower opening and a plug for closing the lower opening (both are not shown). Accordingly, the ink or air bubbles overflowing from the vertical supply tank 911V reach(es) the drainer 82 via the mounting pipe 71, the vertical pipe 72, the branch pipe 73 and the discharge pipe 81. The drainer 82 stores the ink or air bubbles having reached the drainer 82. If an operator opens the plug of the drainer 82, the ink or air bubbles is/are discharged downward from the drainer 82. Note that a discharge pipe 81 and a drainer 82 are similarly configured also for the vertical collection tank 921V.

The air buffer 97a includes an air buffer body 973, a mounting part 974, which is mounted on one end (lower end) of the air buffer body 973, and a mounting part 975, which is mounted on the other end (upper end) of the air buffer body 973. The air buffer body 973 is a pipe extending in the vertical direction Z. An inner diameter of the air buffer body 973 is larger than those of the horizontal pipe 74 and the connection pipe 75. Here, the inner diameters of the horizontal pipe 74 and the connection pipe 75 are equal, but these may be different. The mounting part 974 projects downward from the lower end of the air buffer body 973. A lower end part of this mounting part 974 is bent toward the (−X) side, and an end on the (−X) side of the mounting part 974 is equivalent to the lower end 971 of the air buffer 97a described above. The mounting part 975 projects upward from the upper end of the air buffer body 973, and the upper end of the mounting part 975 is equivalent to the upper end 972 of the air buffer 97a described above.

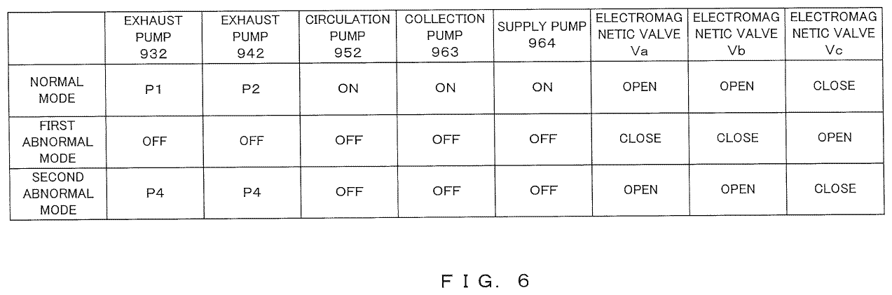

FIG. 6 is a table showing a plurality of modes executable in the ink circulation mechanism in FIG. 3. Each mode of FIG. 6 is executed by a control of the controller 10. A normal mode, a first abnormal mode and a second abnormal mode are shown in FIG. 6.

The normal mode is executed when the operation of the printing apparatus 3 is normal. For example, during the execution of a printing operation of discharging the ink from the nozzles Hn of the discharge heads H to the printing medium M, the normal mode is executed. In the normal mode, the electromagnetic valves Va and Vb are opened and the electromagnetic valve Vc is closed. The exhaust pump 932 generates the pressure P1 in the pressure tank 931, and this pressure P1 is applied to the ink storage part 911L of the supply tank 911. The exhaust pump 942 generates the pressure P2 in the pressure tank 941, and this pressure P2 is applied to the ink storage part 921L of the collection tank 921. As a result, the ink is fed along the second path Cb due to a difference between the pressures P1 and P2. Further, the circulation pump 952 is activated (ON), and the ink is fed along the first path Ca. Furthermore, the collection pump 963 and supply pump 964 are activated (ON), and the ink is fed along the third path Cc.

In the first abnormal mode, any of the exhaust pump 932, the exhaust pump 942, the circulation pump 952, the collection pump 963 and the supply pump 964 are stopped. The electromagnetic valve Va is closed to isolate the pressure tank 931 and the supply tank 911 from each other, and the electromagnetic valve Vb is closed to isolate the pressure tank 941 and the collection tank 921 from each other. Then, the electromagnetic valve Vc is opened, whereby the space 911G of the supply tank 911 and the space 921G of the collection tank 921 communicate. As a result, the same pressure P3 is applied to each of the air-liquid interfaces L1 and L2, and the feed of the ink along the second path Cb is stopped.

In the second abnormal mode, the electromagnetic valves Va and Vb are opened and the electromagnetic valve Vc is closed. The exhaust pump 932 generates a pressure P4 (negative pressure) in the pressure tank 931, and the exhaust pump 942 generates the pressure P4 in the pressure tank 941. Thus, the same pressure P4 is applied to the air-liquid interface L1 in the supply tank 911 and the second air-liquid interface L2 in the collection tank 921, and the feed of the ink along the second path Cb is stopped. Note that the pressure P4 (abnormal time pressure) is a pressure for preventing the outflow of the ink from the nozzles Hn against a difference between a water head pressure of the ink generated due to a height difference between the supply tank 911 and the discharge heads H and a water head pressure of the ink generated due to a height difference between the collection tank 921 and the discharge heads H. Further, any of the circulation pump 952, the collection pump 963 and the supply pump 964 are stopped. Therefore, the feed of the ink along the first path Ca is stopped, and the feed of the ink along the third path Cc is stopped.

As described above, the sensor Sa is provided in the pressure transmission pipe 934 between the supply tank 911 and the air filter Fa. Further, the sensor Sb is provided in the pressure transmission pipe 944 between the collection tank 921 and the air filter Fb. In contrast, the controller 10 switches the mode between the normal mode and the second abnormal mode based on the detection results of the sensors Sa and Sb.

That is, during the execution of the normal mode, the controller 10 monitors the detection results of the respective sensors Sa and Sb. Then, if at least one of the sensors Sa and Sb detects the ink or air bubbles, the controller 10 executes the second abnormal mode. Further, the controller 10 causes the UI 11 to notify a warning.

In the embodiment described above, the sensor Sa is provided which detects the ink or air bubbles in the pressure transmission pipe 934 (first air pipe) between the supply tank 911 (first reservoir tank) and the air filter Fa. Therefore, the overflow of the ink or air bubbles to the pressure transmission pipe 934 connecting the supply tank 911 and the pressure generator 93 (pressure generator) can be detected before these reach the air filter Fa provided in the pressure transmission pipe 934.

Similarly, the sensor Sb is provided which detects the ink or air bubbles in the pressure transmission pipe 944 (first air pipe) between the collection tank 921 (first reservoir tank) and the air filter Fb (first air filter). Therefore, the overflow of the ink or air bubbles to the pressure transmission pipe 944 connecting the collection tank 921 and the pressure generator 94 (pressure generator) can be detected before these reach the air filter Fb provided in the pressure transmission pipe 944.

Further, the air buffer 97a is provided which is mounted in the pressure transmission pipe 934 between the sensor Sa and the air filter Fa. In this way, the movements of the ink or air bubbles having reached the sensor Sa are retarded, and these can be suppressed from reaching the air filter Fa.

The volume of this air buffer 97a is smaller than that of the supply tank 911. In such a configuration, the enlargement of the printing apparatus 3 can be suppressed by providing the air buffer 97a.

Further, the air buffer 97b is provided which is mounted in the pressure transmission pipe 944 between the sensor Sb and the air filter Fb. In this way, the movements of the ink or air bubbles having reached the sensor Sb are retarded, and these can be suppressed from reaching the air filter Fb.

Further, the volume of this air buffer 97b is smaller than that of the collection tank 921. In such a configuration, the enlargement of the printing apparatus 3 can be suppressed by providing the air buffer 97b.

Further, if the sensor Sa or Sb detects the ink or air bubbles, the UI 11 notifies a user. In such a configuration, the user can take a necessary action against the overflow of the ink or air bubbles to the pressure transmission pipe 934 or 944. For example, the user can perform an operation of removing the ink or air bubbles from the drainer 82.

Further, the controller 10 applies the same pressure P4 (abnormal time pressure) to the air-liquid interface L1 of the supply tank 911 and the air-liquid interface L2 of the collection tank 921 if the sensor Sa or Sb detects the ink or air bubbles. In such a configuration, if the sensor Sa or Sb detects the overflow of the ink or air bubbles to the pressure transmission pipe 934 or 944, any further overflow of the ink or air bubbles from the collection tank 921 or the supply tank 911 can be suppressed by stopping the flow of the ink between the collection tank 921 and the supply tank 911.

Further, the supply tank 911 and the collection tank 921 are arranged above the discharge heads H (recording heads). In contrast, the pressure P4 (abnormal time pressure) is a pressure for preventing the outflow of the ink from the nozzles Hn against the difference between the water head pressure of the ink generated due to the height difference between the supply tank 911 and the discharge heads H and the water head pressure of the ink generated due to the height difference between the collection tank 921 and the discharge heads H. In such a configuration, the contamination of the inside of the printing apparatus 3 and the floor, on which the printing apparatus 3 is installed, can be avoided by preventing the outflow of the ink from the nozzles Hn of the discharge heads H.

Further, the circulation pump 952 is provided which feeds the ink between the collection tank 921 and the supply tank 911. In contrast, if the sensor Sa or Sb detects the ink or air bubbles, the controller 10 stops the circulation pump 952. In such a configuration, if the sensor Sa or Sb detects the overflow of the ink or air bubbles to the pressure transmission pipe 934 or 944, any further overflow of the ink or air bubbles from the collection tank 921 or the supply tank 911 can be suppressed by stopping the flow of the ink between the collection tank 921 and the supply tank 911.

Further, the main tank 96 which stores the ink, the collection pump 963 which feeds the ink between the main tank 96 and the supply tank 911 and the supply pump 964 which feeds the ink between the main tank 96 and the collection tank 921 are provided. In contrast, if the sensor Sa or Sb detects the ink or air bubbles, the controller 10 stops the collection pump 963 and the supply pump 964. In such a configuration, if the sensor Sa or Sb detects the overflow of the ink or air bubbles to the pressure transmission pipe 934 or 944, any further overflow of the ink or air bubbles from the collection tank 921 or the supply tank 911 can be suppressed by stopping the flow of the ink between the main tank 96 and the supply tank 911 and the flow of the ink between the main tank 96 and the collection tank 921.

In the embodiment described above, each of the supply tank 911 and the collection tank 921 corresponds to an example of a “first reservoir tank” or a “second reservoir tank” of the disclosure, the discharge head H corresponds to an example of a “recording head” of the disclosure, each of the pressure generators 93, 94 corresponds to an example of a “first pressure generator” or a “second pressure generator” of the disclosure, each of the pressure transmission pipes 934, 944 corresponds to an example of a “first air pipe” or a “second air pipe” of the disclosure, each of the air filters Fa, Fb corresponds to an example of a “first air filter” or a “second air filter” of the disclosure, each of the sensors Sa, Sb corresponds to an example of a “sensor” of the disclosure, each of the air buffers 97a, 97b corresponds to an example of an “air buffer” of the disclosure, the UI 11 corresponds to an example of a “notify unit” of the disclosure, the circulation pump 952 corresponds to an example of a “circulation pump” of the disclosure, and each of the collection pump 963 and the supply pump 964 corresponds to an example of a “first pump” or a “second pump” of the disclosure.

Note that the disclosure is not limited to the embodiment described above and various changes other than the aforementioned ones can be made without departing from the gist of the disclosure. For example, the mode to be executed when the sensor Sa or Sb detects the ink or air bubbles is not limited to the second abnormal mode and may be the first abnormal mode.

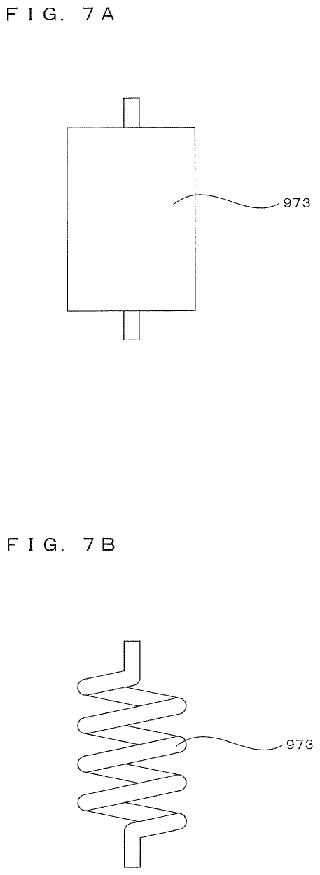

Further, the specific configuration of the air buffer body 973 of the air buffer 97a, 97b needs not be the above pipe. That is, any air buffer can be used if this air buffer has a function of reducing an air flowing speed in an air path as compared to the case where the air path from the sensor Sa, Sb to the air filter Fa, Fb is connected only by the pressure transmission pipe 934, 944. FIGS. 7A and 7B are diagrams schematically showing modifications of the air buffer. In FIG. 7A, the air buffer body 973 is a tank having a cylindrical shape. An inner diameter of this tank is larger than those of the horizontal pipe 74 and the connection pipe 75. Further, in FIG. 7B, the air buffer body 973 is a helical pipe. That is, by configuring the pipe into a helical shape, a length of the pipe is ensured and a volume of the air buffer body 973 is increased.

Further, the specific types of the exhaust pumps 932, 942 are not limited to the diaphragm pumps.

The disclosure is applicable to techniques in general for coping with an overflow of an ink or air bubbles from a reservoir tank communicating with a recording head for discharging the ink.

The printing apparatus may further comprise an air buffer mounted in the first air pipe between the sensor and the first air filter. In this way, the movements of the ink or air bubbles having reached the sensor can be retarded by the air buffer and these can be suppressed from reaching the air filter.

The printing apparatus may be configured so that a volume of the air buffer is smaller than that of the first reservoir tank. In such a configuration, the enlargement of the printing apparatus can be suppressed by providing the air buffer.

The printing apparatus may further comprise a notify unit which notifies a user if the sensor detects the ink or air bubbles. In such a configuration, a user can take a necessary action against the overflow of the ink or air bubbles to the air pipe.

The printing apparatus may further comprises: a second reservoir tank which stores the ink; a second pressure generator which generates a second pressure; a second air pipe which applies the second pressure generated by the second pressure generator to a second space, which is above an ink liquid surface in the second reservoir tank, by connecting the second space and the second pressure generator; and a controller which controls the first pressure generator and the second pressure generator, wherein: the ink storage chamber of the recording head is connected to a second ink storage part to communicate with a second ink storage part, the second ink storage part being a part below the ink liquid surface in the second reservoir tank, and the controller controls the first pressure generator and the second pressure generator so that the first pressure and the second pressure become the same abnormal time pressure if the sensor detects the ink or air bubbles. In such a configuration, if the sensor detects the overflow of the ink or air bubbles to the air pipe, any further overflow of the ink or air bubbles from the reservoir tank can be suppressed by stopping the flow of the ink between the first reservoir tank and the second reservoir tank.

The printing apparatus may be configured so that the first reservoir tank and the second reservoir tank are arranged above the recording head, and the abnormal time pressure is a pressure for preventing the ink from flowing out from the nozzle against a difference between a water head pressure of the ink generated due to a height difference between the first reservoir tank and the recording head and a water head pressure of the ink generated due to a height difference between the second reservoir tank and the recording head. In such a configuration, the contamination of the inside of the printing apparatus and a floor, on which the printing apparatus is installed, can be avoided by preventing the outflow of the ink from the nozzle of the recording head.

The printing apparatus may further comprises a circulation pump which feeds the ink between the first reservoir tank and the second reservoir tank, wherein: the controller stops the circulation pump if the sensor detects the ink or air bubbles. In such a configuration, if the sensor detects the overflow of the ink or air bubbles to the air pipe, any further overflow of the ink or air bubbles from the reservoir tank can be suppressed by stopping the flow of the ink between the first reservoir tank and the second reservoir tank.

The printing apparatus may further comprise: a main tank which stores the ink; a first pump which feeds the ink between the main tank and the first reservoir tank; and a second pump which feeds the ink between the main tank and the second reservoir tank, wherein the controller stops the first pump and the second pump if the sensor detects the ink or air bubbles. In such a configuration, if the sensor detects the overflow of the ink or air bubbles to the air pipe, any further overflow of the ink or air bubbles from the reservoir tank can be suppressed by stopping the flow of the ink between the main tank and the first and second reservoir tanks.

Although the disclosure has been described with reference to specific embodiments, this description is not meant to be construed in a limiting sense. Various modifications of the disclosed embodiment, as well as other embodiments of the present disclosure, will become apparent to persons skilled in the art upon reference to the description of the disclosure. It is therefore contemplated that the appended claims will cover any such modifications or embodiments as fall within the true scope of the disclosure.

What is claimed is:

1. A printing apparatus, comprising:
a first reservoir tank which stores an ink;
a recording head which includes an ink storage chamber, which is connected to a first ink storage part being a part below an ink liquid surface in the first reservoir tank and communicates with the first ink storage part, and discharges the ink stored in the ink storage chamber from a nozzle;
a first pressure generator which generates a first pressure;
a first air pipe which applies the first pressure generated by the first pressure generator to a first space, which is above the ink liquid surface in the first reservoir tank, by connecting the first space and the first pressure generator;
a first air filter which is provided in the first air pipe between the first reservoir tank and the first pressure generator and removes foreign matters from air in the first air pipe; and
a sensor which detects the ink or air bubbles in the first air pipe between the first reservoir tank and the first air filter.

2. The printing apparatus according to claim 1, further comprising an air buffer mounted in the first air pipe between the sensor and the first air filter.

3. The printing apparatus according to claim 2, wherein:
a volume of the air buffer is smaller than that of the first reservoir tank.

4. The printing apparatus according to claim 1, further comprising a notify unit which notifies a user if the sensor detects the ink or air bubbles.

5. The printing apparatus according to claim 1, further comprising:
a second reservoir tank which stores the ink;
a second pressure generator which generates a second pressure;
a second air pipe which applies the second pressure generated by the second pressure generator to a second space, which is above an ink liquid surface in the second reservoir tank, by connecting the second space and the second pressure generator; and
a controller which controls the first pressure generator and the second pressure generator,
wherein:
the ink storage chamber of the recording head is connected to a second ink storage part to communicate with a second ink storage part, the second ink storage part being a part below the ink liquid surface in the second reservoir tank, and the controller controls the first pressure generator and the second pressure generator so that the first pressure and the second pressure become the same abnormal time pressure if the sensor detects the ink or air bubbles.

6. The printing apparatus according to claim 5, wherein:
the first reservoir tank and the second reservoir tank are arranged above the recording head, and
the abnormal time pressure is a pressure for preventing the ink from flowing out from the nozzle against a difference between a water head pressure of the ink generated due to a height difference between the first reservoir tank and the recording head and a water head pressure of the ink generated due to a height difference between the second reservoir tank and the recording head.

7. The printing apparatus according to claim 5, further comprising a circulation pump which feeds the ink between the first reservoir tank and the second reservoir tank, wherein:
the controller stops the circulation pump if the sensor detects the ink or air bubbles.

8. The printing apparatus according to claim 5, further comprising:
a main tank which stores the ink;
a first pump which feeds the ink between the main tank and the first reservoir tank; and
a second pump which feeds the ink between the main tank and the second reservoir tank,
wherein the controller stops the first pump and the second pump if the sensor detects the ink or air bubbles.

9. A print control method, comprising:
applying a first pressure to a first space via a first air pipe, the first pressure being generated by a first pressure generator for generating the first pressure, the first space being above an ink liquid surface in a first reservoir tank for storing an ink, the first air pipe connecting the first space and the first pressure generator;
discharging the ink stored in an ink storage chamber from a nozzle by a recording head including the ink storage chamber, which is connected to the first ink storage part to communicate with a first ink storage part, the first ink storage part being a part below the ink liquid surface in the first reservoir tank; and
detecting the ink or air bubbles in the first air pipe between a first air filter and the first reservoir tank by a sensor, the first air filter being provided in the first air pipe between the first reservoir tank and the first pressure generator to remove foreign matters from air in the first air pipe.
